(19) United States
(12) Patent Application Publication
(10) Pub. No.: US 2007/0046453 A1
(43) Pub. Date: Mar. 1, 2007

(54) Meter mounting structure of motorcycle

(76) Inventors: Yasuhisa Okabe, Akashi-shi (JP); Hideo Beppu, Inashiki-gun (JP); Mikio Domoto, Kakogawa-shi (JP); Ryota Obuki, Kobe-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/502,354

(22) Filed: Aug. 11, 2006

(30) Foreign Application Priority Data
Aug. 15, 2005 (JP) P2005-235308

(51) Int. Cl. B60Q 1/00; G09F 9/00

(52) U.S. Cl. 340/461

(57) ABSTRACT

Disclosed is a meter mounting structure of a motorcycle realizing improvement in visibility of a meter. A meter includes a plurality of displays which are disposed in tandem in a direction of the sight line of a rider and is mounted near a handle. The meter is mounted inclined with respect to a reference plane orthogonal to the sight line such that a lower half portion of each of the displays is positioned closer to an eye point than an upper half portion thereof. Preferably, the meter is mounted such that the lower end of the display on the rear side in the direction of the sight line is disposed in almost the same position as that of the display on the front side in the direction of the sight line in the case where the meter is disposed parallel with the reference plane.

### BACKGROUND OF THE INVENTION

1. Field of the Invention

The present invention relates to a meter mounting structure of a motorcycle.

2. Description of the Related Art

FIGS. 3 and 4 show a meter used for a motorcycle. In a meter 30, a circular-shaped opening 32A is formed in the front face of a casing 32, the opening 32A is covered with a cover member 33 having a transparent cover 34, and two displays 41 and 42 are provided in the casing 32. FIG. 4 is a cross sectional view taken along a line IV-IV of FIG. 3. The two displays 41 and 42 are disposed with an interval in the direction of a sight line as seen from the front. In more detail, the display 41 is disposed in front of the display 42 to have the interval therebetween as shown in FIG. 4.

In FIG. 3, the display 41 on the front side in the direction of the sight line (the side of the cover member 33) indicates vehicle speed, water temperature, and the like in a center portion of a liquid crystal panel 43 by liquid crystal (43A). An outer peripheral portion of the liquid crystal panel 43 is a transparent portion 43B. The display 42 on the rear side in the direction of the sight line (the side opposite to the cover member 33) is provided to indicate engine speed and has a dial plate 44 on which indication designs such as scale M, numerals N, and the like are displayed and a pointer 45 pointing the indication designs M and N. The indication designs M and N on the dial plate 44 and the tip of the pointer 45 can be seen from the front via the transparent portion 43B in the liquid crystal panel 43.

Japanese Design Registration No. 1,169,272 discloses a display device for vehicle having a see-thru portion in a dial plate such that another display plate provided on the rear side of the dial plate can be seen from the front.

In the meter 30 shown in FIGS. 3 and 4, since the display 42 for the engine speed is set back far from the cover member 33, the display 42 is not seen easily compared with the display 43 for the vehicle speed and the like. When travel speed of the motorcycle is high, a rider riding on the motorcycle is in a forward leaning position, and an eye point of the rider is closer to the meter 30. Consequently, there is not much influence even when the display 42 for engine speed is provided on the rear side of the display 43. However, when travel speed is slow, the rider is in a non-leaning position and the eye point moves apart from the display 42, so that visibility deteriorates.

### SUMMARY OF THE INVENTION

The present invention addresses the above described condition, and an object of the present invention is to provide a meter mounting structure of a motorcycle which realizes improvement in visibility of a meter in which a plurality of displays are provided in tandem in a direction of a sight line of a rider riding on the motorcycle.

In order to achieve the object mentioned above, in accordance with the present invention, there is provided a meter mounting structure of a motorcycle for mounting a meter near a handle of the motorcycle, the meter having a plurality of displays which are disposed in tandem in a direction of a sight line of a rider riding on the motorcycle, wherein the meter is mounted so as to tilt with respect to a reference plane orthogonal to the sight line such that a lower half portion of each of the displays is disposed closer to an eye point of the rider than an upper half portion of each of the displays.

For example, in the case where the display on the rear side in the direction of the sight line shows engine speed by a dial plate and a pointer, when the travel speed of a motorcycle is slow, the engine speed is also low, so that the pointer points a lower half portion of the dial plate. Therefore, by tilting the meter such that the lower half portion of the display is positioned closer to the eye point, even when the travel speed is low and the rider is in the non-leaning position (back straight position), the display on the rear side can be easily seen, and visibility improves. On the other hand, an upper half portion of the display on the rear side in the direction of the sight line is positioned far from the eye point. However, since the engine speed is high when the pointer points the upper half portion of the dial plate, the travel speed of the motorcycle is high and the rider is in the forward leaning position. Therefore, the eye point of the rider is closer to the meter, so that the rider can see the upper half portion of the display well. Since it is sufficient to change the mounting angle of the meter and it is unnecessary to change the structure of the meter itself, visibility of the meter can be improved easily and cheaply.

Preferably, the meter may be mounted such that a lower end of the display on the rear side in the direction of the sight line out of the plurality of displays is disposed in almost the same position as that of the display on the front side in the direction of sight line in the case where the meter is disposed in parallel with the reference plane.

In accordance with this structure, even when the travel speed of the motorcycle is slow and the rider is in the non-leaning position, visibility similar to that in the conventional technique can be obtained.

Preferably, the display on the rear side in the direction of the sight line out of the plurality of displays may have a number of indication designs which are continuous from the lower half portion to the upper half portion of the display, and the indication designs in the upper half portion are formed larger than the indication designs in the lower half portion.

In accordance with this structure, even when the upper half portion of the display is apart from the eye point, it is easily seen. Thus, visibility of the whole display can be improved. The indication designs denote scale, numerals, characters, and the like.

Preferably, the indication designs may be formed such that their size gradually increases from the lower half portion to the upper half portion of the display.

In accordance with this structure, the size of the indication designs in the display can be changed naturally.

### BRIEF DESCRIPTION OF THE DRAWINGS

This and other objects and features of the present invention will become more clear from the following description taken in conjunction with a preferred embodiment thereof with reference to the accompanying drawings.

FIG. 1 is a left side view of a motorcycle which employs a meter mounting structure according to an embodiment of the present invention.

FIG. 2 is an enlarged left side view of a handle portion of the motorcycle in FIG. 1.

FIG. 3 is a front view of a meter of the motorcycle.

FIG. 4 is a cross sectional view taken line IV-IV of FIG. 3.

### DETAILED DESCRIPTION OF THE PREFERRED EMBODIMENTS

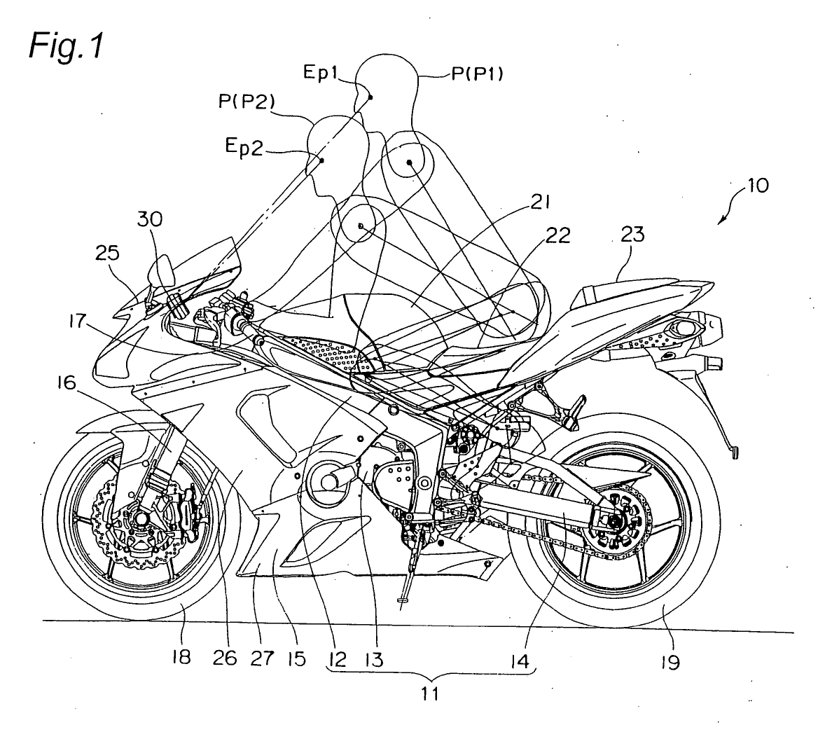

FIG. 1 is a left side view of a motorcycle which employs a meter mounting structure according to an embodiment of the invention. A motorcycle 10 has a vehicle body 11 including a body frame 12, an engine 13, and a swing arm 14, and a cowling 15 covering an outer faces of the vehicle body 11. A front fork 16 is supported at a front end of the body frame 12, a handle 17 is provided at an upper end of the front fork 16, and a front wheel 18 is supported at a lower end of the front fork 16.

A front end of the swing arm 14 is supported to a lower end of the body frame 12 so as to freely swing in a vertical direction, and a rear wheel 19 is supported to a rear end of the swing arm 14. A fuel tank 21, a seat 22, and a rear seat 23 are provided in order from the front side of motorcycle on the upper side of the body frame 12. The engine 13 is disposed below the fuel tank 21 and the handle 17 is disposed on the front side of the fuel tank 21.

The cowling 15 is constituted by a front cowling 25 covering around the handle 17, side cowlings 26 mainly covering both right and left sides of the engine 13, and a lower cowling 27 mainly covering the lower side of the engine 13.

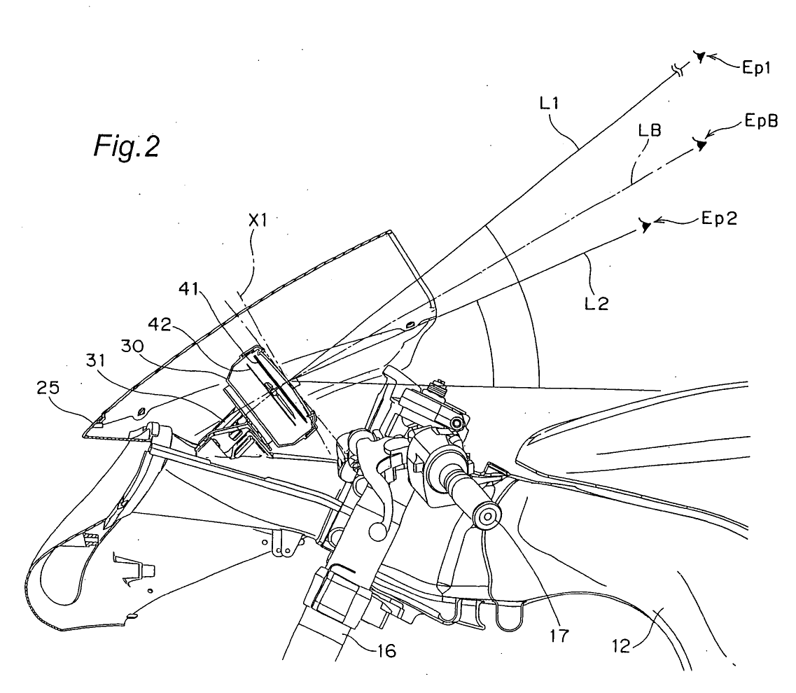

FIG. 2 is an enlarged left side view (partial cross section) of the handle 17 portion. In the front cowling 25, a meter 30 showing vehicle speed, engine speed, and the like is provided. The meter 30 is mounted to the front cowling 25 or the front fork 16 via a bracket 31.

[Structure of Meter]

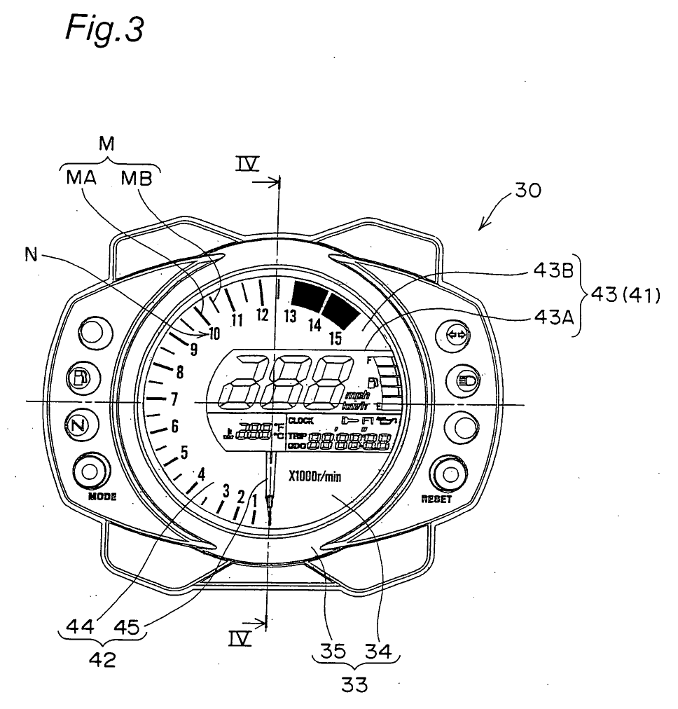

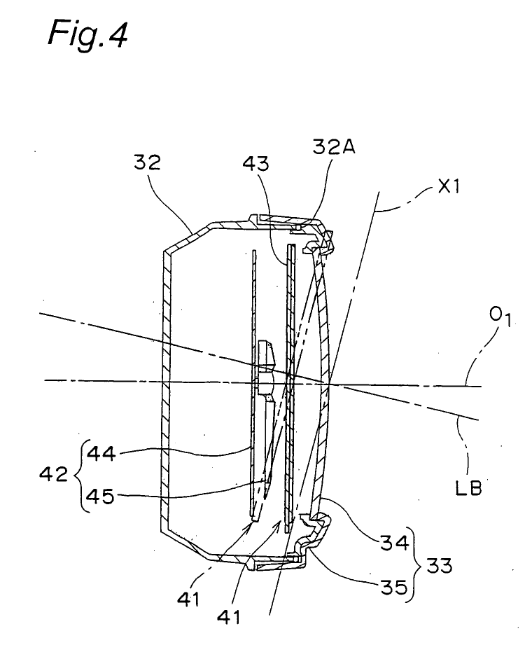

FIG. 3 is a front view of the meter 30. FIG. 4 is a cross sectional view taken along line IV-IV of FIG. 3. As shown in FIGS. 3 and 4, the meter 30 includes an almost-cup-shaped casing 31 having an opening 32A in the front thereof, and the cover member 33 closing the opening 32A in the casing 32. The cover member 33 is constituted by a circular transparent cover 34 made of glass, plastic, or the like and a mounting edge element 35 provided in an outer periphery of the circular transparent cover 34. The cover member 33 is fixed to the casing 32 by fitting or screwing the mounting edge element 35 to a periphery of the opening 32A in the casing 32. A plurality of displays 41 and 42 are disposed in the casing 32.

The plurality of displays include a first display 41 for displaying vehicle speed, water temperature, fuel residual quantity, and the like, and a second display 42 for displaying engine speed. The first and second displays 41 and 42 are disposed in tandem in a direction of a sight line as the meter 30 is viewed from the front by a rider riding on the motorcycle. The first display 41 is disposed on the front side (the side near the rider) in the direction of the sight line, and the second display 42 is disposed on the rear side (the side far from the rider) in the direction of the sight line.

The first display 41 displays vehicle speed and the like by using liquid crystal. The first display 41 includes a liquid crystal panel 43 having the size corresponding to the transparent cover 34. The liquid crystal panel 43 includes a display portion 43A formed in a long band shape which extends in the horizontal direction from the center to the right end of the liquid crystal panel 43. The vehicle speed and the like are displayed digitally and concentrically in the display portion 43A. A portion of the liquid crystal panel 43 out side of the display portion 43A is a transparent portion (see-thru portion) 43B. Via the transparent portion 43B, the second display 42 can be seen from the front side of the meter 30.

The second display 42 has a dial plate 44 and a pointer 45. The dial plate 44 is formed in size corresponding to the transparent cover 34, and has scale M and numerals N in the peripheral portion corresponding to the transparent portion 43B in the liquid crystal panel 43. The scale M is made of short lines which are directed in the radial direction of the dial plate 44 and are continuously provided along a periphery of the dial plate 44 in the range from a lowermost position past a uppermost position of the dial plate 44. The numerals N are attached on the inside in a radial direction of the scale M and are 0 to 15 indicative of the engine speed 0 rpm to 15,000 rpm in the example of FIG. 3. The scale M is constructed by main divisions MA of thick lines and sub divisions MB of thin lines. The numerals N are attached in correspondence with the main divisions MA, and the sub divisions MB are disposed between the main divisions MA.

The lowest main division MA to which the numeral N of 0 is attached is the shortest, and the main divisions MA gradually become longer toward the top of the dial plate 44. Similarly, the lowest sub division MB is the shortest and the sub divisions MB gradually become longer toward the top of the dial plate 44.

One end of the pointer 45 is rotatably supported in the center of the dial plate 44, and the other end of the pointer 45 extends to a portion near the indication designs M and N. In the center portion of the dial plate 44, the pointer 45 is hidden by the display portion 43A of the liquid crystal panel 43, and only the tip of the pointer 45 can be seen from the front.

[Mounting Structure of Meter]

As shown in FIG. 1, a rider P riding on the motorcycle 10 has a low posture (in a forward leaning position) shown by P2 when the travel speed is high, and an eye point Ep2 of the rider P2 is closer to the meter 30. On the contrary, when the travel speed is low, the rider P1 has a high posture (in a non-leaning position), and an eye point Ep1 of the rider P1 is far from the meter 30.

On the other hand, as shown in FIG. 4, the second display 42 in the meter 30 is disposed on the rear side of the transparent cover 34 in the direction of the sight line, so that visibility of the second display 42 is slightly lower than that of the first display 41. In particular, when the rider P is in the non-leaning position (P1 in FIG. 1), the eye point Ep1 is far from the meter 30, so that the visibility of the second display 42 decreases. Therefore, in the present invention, as will be described below, the mounting angle of the meter 30 is devised such that the rider can easily see the second display 42 even in the non-leaning position (P1).

In FIG. 2, EpB denotes an eye point (a standard eye point) derived from a standard body frame of the rider P specified by JASO (Japanese Automobile Standard Organization). Generally, the mounting angle of the meter 30 is determined in designing by the standard eye point EpB. In FIG. 2, a sight line (a standard sight line) when the rider P sees the meter 30 from the standard eye point EpB is indicated by LB. The standard sight line LB is set between a sight line L1 when the rider P1 in the non-leaning position sees the meter 30 and a sight line L2 when the rider P2 in the forward leaning position sees the meter 30.

In conventional technique, the meter 30 is provided so as to be almost perpendicular to the standard sight line LB of the rider P. To be specific, in the case of setting an imaginary reference plane X1 orthogonal to the standard sight line LB of the rider P, the meter 30 is provided such that the first and second displays 41 and 42 are parallel with the reference plane X1. In contrast, in the embodiment, the meter 30 is mounted such that the displays 41 and 42 are inclined upward with respect to the reference plane X1, so that the lower-half portion of each of the displays 41 and 42 is disposed closer to the standard eye point EpB than the upper-half portion thereof.

The tilt angle with respect to the reference plane X1 of the meter 30 is set such that, as shown in FIG. 4, the lower end of the second display 42 is disposed in a position which is almost the same as a position of the first display 41 (shown by the imaginary line) in the case where the meter 30 is attached in parallel with the reference plane X1 like in the conventional technique.

### Effects of the Embodiment

(1) In the case where the motorcycle 10 is driven at low speed, as shown in FIG. 1, the rider P1 is in the non-leaning position, and the eye point Ep1 is far from the meter 30. As shown in FIG. 3, in the case of low-speed travel, the engine speed is low, so that the pointer 45 mainly points the lower half portion of the dial plate 44 in the second display 42 of the meter 30.

As shown in FIG. 2, the meter 30 tilts with respect to the reference plane X1 such that the lower half portion of the second display 42 is positioned closer to the eye point EpB than the upper half portion. Consequently, the lower half portion of the second display 42 that the pointer 45 points can be positioned closer to the eye point Ep1 than that in the conventional technique. Thus, visibility of the second display 42 on the deep side in the direction of the sight line can be improved.

On the contrary, in the case where the motorcycle 10 is driven at high speed, the rider P2 is in the forward leaning position and the eye point Ep2 comes closer to the meter 30. Consequently, even when the pointer 45 of the second display 42 in FIG. 3 points the upper half portion of the dial plate 44, visibility does not deteriorate.

(2) As shown in FIG. 4, the tilt angle of the meter 30 with respect to the reference plane X1 is set such that the lower end of the second display 42 is disposed in almost the same position as that of the first display 41 (shown by the imaginary line) of the conventional technique. Therefore, visibility almost equivalent to that of the conventional first display 41 can be provided for the second display 42.

(3) As shown in FIG. 3, the length of the scale M gradually increases from the lower half part to the upper half part in the dial plate 44 of the second display 42. Consequently, deterioration in visibility as the upper half part of the second display 42 moves apart from the eye point at the time of low speed travel can be suppressed.

(4) To improve visibility of the second display 42, only the mounting angle of the meter 30 is changed. It is therefore unnecessary to change design of the meter itself such as change in the angles of the displays 41 and 42 with respect to the casing 32. Therefore, improvement of visibility can be realized easily and cheaply.

### Other Embodiments

(1) Although the length of the scale M of the second display 42 is gradually increased from the lower half portion to the upper half portion in the foregoing embodiment, alternately, the length of the numerals N may be gradually increased from the lower half portion to the upper half portion. Not necessarily the length but width or width and length can be increased.

(2) The invention is not limited to the case where the length of the divisions of the scale M is gradually increased from the lower half portion to the upper half portion. It is also possible to set that, for example, the divisions of the scale M in the lower half portion are uniformly short, and those in the upper half portion are uniformly long.

(3) Although the first display 41 shows a plurality of indications such as vehicle speed and water temperature, it can also show a single indication such as only vehicle speed.

(4) The first display 41 may perform analog display with the pointer and the dial plate, and the second display 42 may perform digital display with liquid crystal.

(5) The first display 41 may be used as a display of the engine speed, and the second display 42 may be used as a display of velocity and the like.

(6) The number of displays of the meter 30 is not limited to two but may be three or more.

(7) In the foregoing embodiment, as shown in FIG. 4, the tilt angle with respect to the reference plane X1 of the meter 30 is set such that the lower end of the second display 42 is disposed in almost the same position as that of the first display 41 (shown by the imaginary line) in the case where the meter 30 is mounted parallel with the reference plane X1 as in the conventional technique. The tilt angle is not necessarily set like this. It is sufficient to make the lower half portion of the meter 30 tilt so as to be closer to the eye point than the upper half portion.

Although the invention has been described in its preferred embodiments with a certain degree of particularity, obviously many changes and variations are possible therein. It is therefore to be understood that the present invention may be practical otherwise than as specifically described herein with out departing from the scope and spirit thereof.

What is claimed is:

1. A meter mounting structure of a motorcycle for mounting a meter near a handle of the motorcycle, the meter having a plurality of displays which are disposed in tandem in a direction of a sight line of a rider riding on the motorcycle,
wherein the meter is mounted so as to tilt with respect to a reference plane orthogonal to the sight line such that a lower half portion of each of the displays is disposed closer to an eye point of the rider than an upper half portion of each of the displays.

2. The meter mounting structure of the motorcycle as claimed in claim 1, wherein the meter is mounted such that a lower end of the display on the rear side in the direction of the sight line out of the plurality of displays is disposed in almost the same position as that of the display on the front side in the direction of sight line in the case where the meter is disposed in parallel with the reference plane.

3. The meter mounting structure of the motorcycle as claimed in claim 1, wherein the display on the rear side in the direction of the sight line out of the plurality of displays has a number of indication designs which are continuous from the lower half portion to the upper half portion of the display, and the indication designs in the upper half portion are formed larger than the indication designs in the lower half portion.

4. The meter mounting structure of the motorcycle as claimed in claim 3, wherein the indication designs are formed such that their size gradually increases from the lower half portion to the upper half portion of the display.
